(19) United States
(12) Patent Application Publication
(10) Pub. No.: US 2006/0216444 A1
(43) Pub. Date: Sep. 28, 2006

(54) Inkjet recording medium and method for producing the same

(76) Inventors: Masayoshi Yamauchi, Tokyo (JP); Kazumasa Matsumoto, Tokyo (JP); Makoto Kaga, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/388,151

(22) Filed: Mar. 23, 2006

(30) Foreign Application Priority Data
Mar. 28, 2005 (JP) JP2005-090825

(51) Int. Cl. B41M 5/00

(52) U.S. Cl. 428/32.34

(57) ABSTRACT

An inkjet recording medium comprising a support containing a cellulose pulp having thereon an ink-absorbing layer, wherein the support is applied with an aqueous coating solution comprising an aqueous emulsion resin on a surface where the ink-absorbing layer is to be provided, followed by being pressed with a surface smoothing roller at a temperature not higher than a glass transition temperature of the aqueous emulsion resin.

This application is based on Japanese Patent Application No. 2005-090825 filed on Mar. 28, 2005, and No. 2006-003407 filed on Jan. 11, 2006 in Japanese Patent Office, the entire content of which is hereby incorporated by reference.

### FIELD OF THE INVENTION

The present invention relates to an inkjet recording medium used for inkjet recording method and to a method for producing the recording medium.

### BACKGROUND OF THE INVENTION

Inkjet recording is a method of recording images and characters by ejecting very fine droplets of ink based on different principles of operation which are deposited on an inkjet recording medium such as paper, and because it has the advantages of relatively high speed, low noise, and ease of multi-color reproduction, it is spreading widely in various fields such as different types of printers, facsimile equipment, computer terminals.

In the inkjet recording media used in such inkjet recording method, it is necessary that the density of the printed dots is high, the color tones should be bright and vivid, the ink absorbing capacity is high, the ink should not overflow or smudge even when the printed dots overlap each other, the spreading of the printed dots in the horizontal direction should not be larger than is necessary, and also the contour should be smooth and not blurred. In addition, in recent years, significant improvements are seen even in the storage stability of printed images, and on the whole, image quality and image storage stability are approaching those of silver halide photography.

In addition to these, in order to achieve high quality inkjet images close to silver halide photograph images, other very important characteristics are the gloss and image clarity of the surface of the inkjet recording medium. If the gloss and image clarity of the surface of the inkjet recording medium are low, the vividness of the image decreases, and even regarding the three-dimensional appearance, the images very often appear to be lacking in depth. Therefore, inkjet glossy paper advocating to offer photograph quality, in most cases, use a resin coated support which is the same paper support used in silver halide photographs but with both their surfaces covered with plastic layers. The resin coated support not only has high surface smoothness, high gloss, and also image clarity, but also has water resistance, and hence, at the time of coating an ink-absorbing layer on the support, the water in the ink-absorbing layer coating liquid does not penetrate the support, and there is no occurrence of reduction in the smoothness, or reductions in gloss or image clarity due to cockling (defects of generation of wrinkles resulting in loss of flatness) of the support. However, such high quality resin coated support not only have their application limited but also are expensive, and hence at present it is unavoidable that the cost of photograph quality inkjet recording medium also becomes high.

On the other hand, instead of a resin coated support, paper for inkjet recording has been disclosed (see, for example, Patent Documents 1 to 3) in which gloss and image clarity have been enhanced by coating an ink-absorbing layer on a water absorbent support, and thereafter, increasing the smoothness of the surface of the inkjet recording medium by carrying out a casting process or a calender process. Such inkjet recording media are referred to as the so called cast coated sheets for inkjet recording, and it is possible to provide them at a lower cost than the recording media that use resin coated supports. However, since ink penetration is high in the ink-absorbing layer that is subjected to the casting process, there was the problem that the ink solution after printing passes through the ink-absorbing layer to the paper support, thereby causing cockling and thus lowering image quality.

To counter this problem, a technology has been disclosed that suppresses the generation of cockling by preventing the penetration of the ink to the paper support by providing a new layer between the ink-absorbing layer and the paper support. For example, a technology has been disclosed (see, for example, Patent Document 4) in which generation of cockling after printing has been reduced by providing, between the ordinary paper support and the ink-absorbing layer, a layer having inorganic particles and an adhesive with a glass transition temperature of 30 to 60° C. According to the method disclosed in Patent Document 4, although the generation of cockling is suppressed by enhancing the rigidity of the entire recording paper by providing a resin layer with a high glass transition temperature, that is, with a high rigidity as the intermediate layer, the rigidity of the intermediate layer decreases under high temperature and high humidity conditions thereby making it easy for cockling to occur, and hence this method was insufficient as an improvement measure. In addition, even if an intermediate layer described above is provided on an ordinary paper support, the smoothness is still insufficient, and at present this has not yet resulted in obtaining the same level of gloss and image clarity as that of resin coated paper.

On the other hand, a technology has been disclosed (see, for example, Patent Document 5) in which, after coating a aqueous emulsion resin on raw paper and drying it, by carrying out calender processing at a temperature higher than the glass transition temperature Tg, the aqueous emulsion resin is heated and made into a film and made smooth thereby increasing the gloss of the surface of the support. However, because calender processing is done at a temperature higher than the glass transition temperature Tg, and the aqueous emulsion resin adheres to form a film, if an ink-absorbing layer is provided on top of it, the residual organic solvent in the ink that is remaining in the ink-absorbing layer will not at all be absorbed by the aqueous emulsion resin layer, which can cause bleeding of the image depending on the conditions of storage after printing. In addition, since the aqueous emulsion resin becomes soft like rubber at temperatures higher than Tg, there was also the problem that it gets transferred onto the calender roller thereby staining the surface of the roller.

Therefore, it is desired to provide an inkjet recording medium that offers high quality images at a lower cost, that is, an inkjet recording medium that has gloss equivalent to that when a resin coated support is used, has excellent ink absorption characteristics, has no occurrence of cockling after printing, and has satisfactory resistance to image bleeding, and to provide a method of producing such inkjet recording media.

Patent Document 1: Japanese Patent Publication Open to Public Inspection (hereafter referred to as JP-A) No. 62-95285

Patent Document 2: JP-A No. 63-265680

Patent Document 3: JP-A No. 5-59694

Patent Document 4: JP-A No. 5-85035

Patent Document 5: JP-A No. 2004-347722

### SUMMARY OF THE INVENTION

An object of the present invention is to provide an inkjet recording medium having high gloss, ink absorption capacity, resistance to cockling after printing, and excellent resistance to image bleeding, and to provide a method for producing such an inkjet recording medium.

One of the aspects of the present invention is an inkjet recording medium comprising a support containing a cellulose pulp having thereon an ink-absorbing layer, wherein the support is applied with an aqueous coating liquid containing an aqueous emulsion resin on a surface where the ink-absorbing layer is to be provided, followed by being pressed with a surface smoothing roller at a temperature not higher than a glass transition temperature of the aqueous emulsion resin.

### DESCRIPTION OF THE PREFERRED EMBODIMENTS

The above object of the present invention is achieved by the following structures:
(1) An inkjet recording medium containing a support containing a cellulose pulp having thereon an ink-absorbing layer, wherein the support is applied with an aqueous coating liquid containing an aqueous emulsion resin on a surface where the ink-absorbing layer is to be provided, followed by being pressed with a surface smoothing roller at a temperature not higher than a glass transition temperature of the aqueous emulsion resin.
(2) The inkjet recording medium of Item (1), wherein the glass transition temperature of the resin is in the range of 20 to 100° C.
(3) The inkjet recording medium of Item (1) or Item (2), wherein the support is pressed at a line pressure of 1 to 5 kN/cm.
(4) The inkjet recording medium of any one of Items (1) to (3), wherein the ink-absorbing layer has a porous structure.
(5) The inkjet recording medium of Item (4), wherein the porous structure contains an inorganic particles and an organic binder.
(6) The inkjet recording medium of any one of Items (1) to (5), wherein the support is provided with a back coat layer on a surface of the support reverse to a surface having the ink-absorbing layer.
(7) A method for producing an inkjet recording medium containing the steps of:

(i) applying an aqueous coating liquid containing an aqueous emulsion resin on a support containing a cellulose pulp;

(ii) carrying out a surface smoothing treatment by pressing the support applied with the aqueous coating liquid with a roller at a temperature not higher than a glass transition temperature of the aqueous emulsion resin; and

(iii) providing an ink-absorbing layer on a surface of the support where the aqueous coating liquid is applied.
(8) The method of Item (7), wherein the glass transition temperature of the resin is in the range of 20 to 100° C.
(9) The method of Item (7) or Item (8), wherein the support is pressed at a line pressure of 1 to 5 kN/cm.
(10) The method of any one of Items (7) to (9), wherein the ink-absorbing layer has a porous structure.
(11) The method of Item (10), wherein the porous structure contains an inorganic particles and an organic binder.
(12) The method of any one of Items (7) to (11), wherein the support is provided with a back coat layer on a surface of the support reverse to a surface having the ink-absorbing layer.

In the following, some preferred embodiments of the present invention will be described in detail.

In an inkjet recording medium having at least one ink-absorbing layer on a support, it was found that an inkjet recording medium exhibiting high gloss, high ink absorption capacity, cockling resistance after printing, and excellent resistance to image bleeding is achieved by an inkjet recording medium containing a support containing a cellulose pulp having thereon an ink-absorbing layer, wherein the support is applied with an aqueous coating liquid containing an aqueous emulsion resin on a surface where the ink-absorbing layer is to be provided, followed by being pressed with a surface smoothing roller at a temperature not higher than a glass transition temperature of the aqueous emulsion resin.

The support of the present invention has the feature that, when an aqueous coating liquid to form a constituting layer such as an ink-absorbing layer is coated on the support, the rate of permeation of water into the support is slower than the rate of evaporation of water to dry due to the existence of the resin layer obtained by coating the aqueous emulsion resin (hereafter also referred to as the resin layer of the present invention), and as a result, cockling of the support containing a cellulose pulp as a main component tends not to occur. Further, at the time of carrying out image forming using an aqueous ink on the inkjet recording medium of the present invention (hereafter referred to merely as the recording medium), the water in the aqueous ink is prevented from permeating to the paper support, and hence cockling after printing does not occur. In addition, since the resin layer of the present invention slowly permeates the organic solvent contained in the aqueous ink, it has the function of preventing bleeding of the images. One of the mechanisms of image bleeding is that the colorant (the dye) forming the image is drifted by the residual organic solvent in the ink-absorbing layer.

The inkjet recording medium of the present invention functioning as described above differs from conventional recording media in which a uniform film of a resin is formed, since the resin layer of the present invention has a structure in which particles formed by the aqueous emulsion resin are compactly packed without being fused to each other, and has voids remaining among the resin particles.

In order to form the above described structure using the aqueous emulsion resin particles of the present invention, it was found to be extremely important to carry out surface smoothening operation by pressing the support coated with the aqueous coating liquid containing the aqueous emulsion resin with a pressure in a prescribed pressure range at a temperature not higher than the glass transition temperature (Tg) of the aqueous emulsion resin.

By carrying out the smoothening operation at a temperature not higher than the Tg of the aqueous emulsion resin, although the resin particles in the aqueous emulsion resin are deformed and packed, the state will be one in which there is no fusion of the particles with each other and complete film formation has not been taken place, but very fine voids will remain between the resin particles. These minute voids, at the time of inkjet recording, do not exhibit permeability during the very short period of time from the deposition of ink droplets on the ink-absorbing layer of the inkjet recording medium until the water in the ink is evaporated, and functions as a layer effectively exhibiting water resistant characteristics. On the other hand, at the time of storing the printed material over a long period of time, the minute voids exhibit an appropriate amount of permeability. As a result, at the time of forming print images, the water in the ink is prevented from reaching the paper support thereby suppressing the occurrence of cockling, while, during storage of the printed images over a long time, the generation of image bleeding is suppressed.

In addition, by carrying out smoothening operation on the support, it is possible to provide the same level of smoothness of the surface as that of resin coated paper, and the gloss is excellent after forming the ink-absorbing layer.

Details of the inkjet recording medium of the present invention are explained below

Paper support containing a cellulose pulp as its main constituent is used as the support of the present invention.

Examples of a raw material of the paper support containing a cellulose pulp as its main constituent that can be used in the present invention, include pulps that have wood pulp as the main constituent, for example, chemical pulp such as LBKP, NBKP, mechanical pulp such as GP, CGP, RMP, TMP, CTMP, CMP, PGW, and old paper pulp such as DIP. In addition, it is also possible to use fibrous materials, for example, synthetic pulps, synthetic fibers and inorganic fibers, appropriately, depending on the need.

Depending on the need, it is possible to add to the paper support, various types of conventionally well known additives, for example, a sizing agent, a pigment, a paper strength enhancing agent, a fixing agent, a fluorescent whitening agent, a wet paper strength enhancing agent and a cationizing agent. Examples of a sizing agent include: a higher order fatty acid and an alkylketene dimmer. Examples of a pigment include: calcium carbonate, talc and titanium oxide. Examples of a paper strength enhancing agent include: starch, polyacrylamide and polyvinyl alcohol. Examples of a fixing agent include: aluminum sulphate and cationic polymer electrolyte material. However, the present invention is not limited thereto.

The paper support can be manufactured by mixing fibrous material such as wood pulp with various types of additives using, for example, a fourdrinier paper machine, cylinder paper machine or twin-wire paper machine. Further, if necessary, it is also possible to carry out, in the paper making stage or after paper making, sizing press processing using, for example, starch or polyvinyl alcohol, various types of coating operations, or calender processing.

The support of the present invention has the feature that on the surface of the support on which the ink-absorbing layer having a paper support with cellulose pulp as its main constituent, an aqueous coating liquid having a aqueous emulsion resin is coated, and surface smoothening operation is done by applying pressure at a temperature below the Tg of that aqueous emulsion resin.

The aqueous emulsion resin of the present invention is an emulsion polymerized resin using a polymerization initiator while maintaining an oil-soluble monomer in an emulsion state in an aqueous solution having a dispersing agent, or a so-called soap-free emulsion resin which is polymerized without using a dispersing agent (emulsifier).

Examples of a dispersing agent used at the time of emulsion polymerization of said aqueous emulsion resin include: in general, low-molecular dispersing agents such as alkyl sulfonates, alkyl benzene sulfonates, diethylamine, ethylenediamine and quaternary ammonium salts, and also include: high-molecular dispersing agents such as polyoxyethylene nonyl phenyl ether, polyoxyethylene lauryl ether, hydroxyethyl cellulose and polyvinyl pyrrolidone.

The soap-free method can be a seed method, an oligomer method, or a reactive emulsifier method. In the seed method, a water dispersing resin is prepared beforehand as the seed resin and the polymerization is done by adding the monomer to this, and the seed polymer becomes the core and the part of the polymerized added monomer becomes the shell. The reactive emulsifier method is one in which the additive that is added as the emulsifier at the time of polymerization will be enclosed inside the polymer after polymerization and the structure will be one in which there is no emulsifier at the surface.

The aqueous emulsion resin can be of the acryl copolymer type, styrene-acryl type, polyester type, polyurethane type, polyolefin type, vinyl acetate type, vinyl acetate copolymer type, polystyrene type, polyvinyl chloride type, poly-vinylidene chloride copolymer type, polyvinyl chloride copolymer type, synthetic rubber type, etc.

It is desirable that the aqueous emulsion resin of the present invention is one with its Tg (glass transition temperature) in the range of 20 to 100° C. If the Tg is lower than 20° C., the resin may become rubbery at room temperature to form fused resin layer, and when rolled up in the multi-layer state, there may be problems occurring such as blocking. Further, if the Tg is higher than 100° C., the temperature required for the smoothening operation becomes high, which can modify the nature of cellulose used for the base paper, and hence the smoothening of the base paper may become degraded.

Further, although it is possible to use as the aqueous emulsion resin of the present invention any of the non-ion type, anion type, or cation type ones, it is desirable that it is of the same ion type as the ink-absorbing layer, from the point of view of affinity at the time of coating the coating liquid for the ink-absorbing layer on top of the aqueous emulsion resin layer.

The specific products that can be used as the aqueous emulsion resin are, for example, the T-XP series manufactured by Seiko PMC, the HYDLITH series manufactured by Dai Nippon Ink Chemical Industries, various items of the Nipol LX407 series styrene butadiene type latex for coated paper made by Nihon Zeon such as, Nipol V1004, Nipol MH5055, Nipol LX438C, acrylonitrile butadiene type latex (NBR LATEX) Nipol LX874 etc. that are of the self cross-linking square type, latex for fiber paper forming manufactured by Sumitomo Chemicals such as the vinyl acetate-ethylene type, Sumicaflex S-500, S-706, S-753 etc., vinyl acetate-ethylene-vinyl chloride type S-880, or the SBR L series (L-1970 etc.) of the styrene butadiene type manufactured by Asahi Kasei, or the Polyzol EVA series (AD-6 etc.) manufactured by Showa Polymers.

It is desirable that the film thickness of the aqueous emulsion resin layer of the present invention is in the range of 0.5 to 10 μm. If the thickness of the formed film is less than 0.5 μm, the effect of preventing the permeation of water content etc. becomes small and it is not possible to sufficiently suppress the generation of cockling, and also, if the film thickness is higher than 10 μm, curling can occur easily when handling the inkjet recording medium under different humidity and temperature environments, and, for example, the edge part of the recording medium can easily get soiled or the recording head can get damaged because of the recording medium coming into contact with the recording head of the inkjet printer during printing.

The average particle diameter of the aqueous emulsion resin of the present invention is preferably in the range of 20 to 300 nm. If the average particle diameter is less than 20 nm, the resin particles enter between the fibers of the paper when coated on the paper support thereby causing loss of uniformity of the coated film and hence sufficient smoothness cannot be obtained even if smoothening operation is made. Further, if the average particle diameter is more than 300 nm, the frequency of the minute space between resin particles becomes rare, and it may be impossible to obtain sufficient effect for image bleeding suppression effect. In the present invention, it is also possible to mix together several types of aqueous emulsion resin.

Further, it is desirable to add a release agent in the layer including the aqueous emulsion resin of the present invention. By adding a release agent, at the time of carrying out the surface smoothening operation of the present invention described later, releasing from the roller used for applying pressure becomes easier and hence it is possible to prevent the roller from getting soiled.

In addition, in the aqueous emulsion resin layer of the present invention, as long as its functions (permeation prevention due to very fine voids, and absorption and smoothness characteristics over the long term) are not lost, it is possible to add various types of additives, for example, pigments, water soluble binders (for example, starch, casein, soy protein, CMC, PVA, alkali soluble latex, etc.), dispersing agent, lubricant, anti-foaming agent, water-proofing agent (wax, non-soluble fatty acids, soap, urea, melamine/formalin resin, glyoxal, compounds of heavy metals, etc.), activating agents, pH adjusting agents, fungicide, dyes, etc.

The recording medium of the present invention has the feature that on the surface of the support on which the ink-absorbing layer having a paper support with cellulose pulp as its main constituent, an aqueous coating liquid having the aqueous emulsion resin described above is coated, and after an emulsion layer is formed, a surface smoothening operation is done by applying pressure at a temperature below the Tg of that aqueous emulsion resin.

The surface smoothening operation that can be used in the present invention can be the calender processings using a super calender, gross calender, machine calender, soft calender, etc. The calender processing is that of increasing the gloss of the surface by applying pressure, shear force, and heat by passing the target paper support provided with an emulsion layer through the nip region (the gap) between a metal roller and another roller. As the metal roller, normally a steel roller is used whose surface provided with a protective layer of nickel, chromium, ceramic etc. by flame spray coating, and its surface is polished to a mirror finish. The other roller that is combined with the metal roller can be another metal roller, or an elastic roller, and it is desirable to use an elastic roller from the point of view of uniformity of gloss of the surface of the layer including resin. The elastic roller can be a steel or iron core on which is wound cotton, wool, pulp, etc., which is subjected to a compressing and polishing process, or can be a synthetic resin roller such as a urethane resin roller, an epoxy resin roller, or a polyimide resin roller, or can be an aramid fiber roller.

The method of manufacturing the inkjet recording medium of the present invention has the feature that a surface smoothening processing is carried out at a temperature less than the Tg value of the aqueous emulsion resin that forms the emulsion layer as described above.

If the smoothening operation is made at a temperature higher than the Tg of the aqueous emulsion resin, the emulsion particles described above fuse thereby forming a complete film, and the effect of suppressing image bleeding will not be obtained. Further, it is also likely that the calender roller becomes soiled because the emulsion particles fusing together.

Further, when the Tg of the aqueous emulsion resin is high, since the temperature becomes high if the smoothening operation is done at a temperature above Tg, the cellulose in the paper base gets degenerated due to heat thereby causing reduction in the smoothness and results in decrease in the surface gloss. By observing the temperature conditions stipulated in the present invention, it is possible to realize high surface gloss without any degeneration of the cellulose fibers.

In the smoothening process of the present invention, it is desirable that the linear pressure in the nip region between the metal roller and the other roller during the calender operation is 1 kN/cm or more and less than or equal to 5 kN/cm. If the linear pressure in the nip region is less than 1 kN/cm, the surface smoothening operation will be insufficient and it is difficult to obtain the effect of enhancing the gloss. Also, a linear pressure of more than 5 kN/cm is difficult to realize in the apparatus.

Further, although the desirable nip linear pressure changes depending on the processing speed, it is desirable that the processing is done at a processing speed of 20 m/min or more in at least one nip region. Although there is no particular upper limit on the processing speed, it is desirable that the processing speed is less than 500 m/min from the point of view of quality stability or ease of operation.

Next, explanation is given below regarding the ink-absorbing layer of the present invention.

In an inkjet recording medium of the present invention, although it is possible to use a swelling type ink-absorbing layer or a porous structure type ink-absorbing layer as the ink-absorbing layer provide on top of the water dispersive emulsion layer of the present invention, the desirable one is a porous structure type ink-absorbing layer having a porous structure.

A swelling type ink-absorbing layer is constituted mainly from a hydrophilic resin, and ink is absorbed due to the swelling of the hydrophilic resin. Although it is desirable to use cross-linked gelatin as this hydrophilic resin, it is also possible to use other hydrophilic polymers. For example, it is possible to use either singly or as copolymers various types of cross-linked synthetic hydrophilic copolymers such as polyvinyl alcohol, gelatin derivatives, graft polymer of gelatin and other polymers, proteins such as albumin, casein, etc., cellulose derivatives such as hydroxyethyl cellulose, carboxymethyl cellulose, cellulose sulfate ester, etc., sodium alginate, cellulose sulfate ester, sugar derivates such as dextrin, dextran, dextran sulfate, etc., poly-N-vinyl pyrrolidone, polyacrylic acid, polymethacrylic acid, polyacrylamide, polyvinyl imidazole, polyvinyl pyrazole, etc. As gelatin, apart from lime treated gelatin, it is possible to use together acid treated gelatin, and also, it is possible to use gelatin hydrolysate. It is possible to use these hydrophilic resins either individually or as combinations of several types.

Next, the ink-absorbing layer having a porous structure desirably usable in the inkjet recording medium of the present invention is described below.

The porous structure type ink-absorbing layer can be one in which the porous structure is formed by inorganic particles and organic binder resin, one in which porous structure is created by phase separation of a polymer, or one in which the porous structure is formed by organic particles and organic binder resin.

In the present invention, from the point of view of ink absorption speed, it is desirable to form the porous structure by inorganic particles and organic binder resin in a porous structure type ink-absorbing layer. Further, for water-based in recording, the organic binder resin is desirably a hydrophilic binder resin.

Inorganic particles utilized for the above purpose include white pigments such as light calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, silica, alumina, colloidal alumina, pseudo-boemite, aluminum hydroxide, lithopon, zeolite and magnesium hydroxide.

The diameter of the inorganic particles is preferably not more than 200 nm from the viewpoint of gloss and color appearance even though particles having any diameter may be used. The particle diameter is preferably not less than 5 nm from the viewpoint of production even though there is no specific limitation to the lower limit of particle diameter.

A mean particle diameter of inorganic particles can be determined as a simple averaged value (number average) by observing particles themselves or particles appearing in the cross section or the surface of an ink-absorbing layer and measuring particle diameters of arbitrary 1000 particles. Herein, a particle diameter of each particle is a diameter of a supposed circle having the same projected area as the particle.

In the present invention, as inorganic particles, solid particles, selected from silica, alumina or an alumina hydride, are preferably utilized.

As silica preferably utilized in the present invention, such as silica and colloidal silica synthesized by an ordinary wet method or silica synthesized by a gas phase method are preferable, however, colloidal silica or particlesilica synthesized by a gas phase method are specifically preferably utilized in the present invention; among them, particlesilica synthesized by a gas phase method is preferable because a high void ratio can be obtained as well as coarse aggregates are hardly formed when cationic polymer utilized for the purpose of fixing a dye is added. Further, as alumina or alumina hydride may be either crystalline or amorphous, and any form of such as irregular particles, spherical particles and needle-form particles can be utilized.

Inorganic particles are preferably in a state that a particles dispersion before being mixed with cationic polymer is dispersed to primary particles.

In the present invention, a hydrophilic binder is preferably incorporated in an ink-absorbing layer. Hydrophilic binders utilized in the present invention include, for example, polyvinyl alcohol, gelatin, polyethylene oxide, polyvinyl pyrrolidone, polyacrylic acid, polyacrylamide, polyurethane, dextrane, dextrine, colorgienan (such as κ, ι, λ), agar, pulullan, water-soluble polyvinyl butyral, hydroxyehtyl cellulose and carboxymethyl cellulose. These hydrophilic binders may be utilized in combination of at least two types. Incorporating an organic binder which is cross-linked or polymerized by irradiating ionizing radiation is also one of the preferable embodiments of the present invention.

A hydrophilic binder preferably utilized in the present invention is polyvinyl alcohol.

Polyvinyl alcohol, preferably utilized in the present invention, includes also modified polyvinyl alcohol such as polyvinyl alcohol, the end of which is cationic modified, and anionic modified polyvinyl alcohol provided with an anionic group in addition to ordinary polyvinyl alcohol which is prepared by hydrolysis of polyvinyl acetate.

As polyvinyl alcohol prepared by hydrolysis of vinyl acetate, utilized are those having a mean polymerization degree of preferably not less than 1,000 and specifically preferably 1,500-5,000. Further, the saponification degree is preferably 70-100% and specifically preferably 80-99.5%.

Cationic modified polyvinyl alcohol includes, for example, polyvinyl alcohol provided with a primary-tertiary amino group or a quaternary ammonium group in the main chain or the side chain of the above-described polyvinyl alcohol, which are described in JP-A No. 61-10483, and can be prepared by saponification of a copolymer of an ethylenic unsaturated monomer provided with a cationic group and vinyl acetate.

Ethylenic unsaturated monomer having a cationic group includes such as trimethyl-(2-acrylamide-2,2-dimethylethyl)ammonium chloride, trimethyl-(3-acrylamide-3,3-dimethylpropyl)ammonium chloride, N-vinylimidazole, N-vinyl-2-methylimidazole, N-(3-dimethylaminopropyl)methacrylamide, hydroxylethyltrimethyl ammonium chloride, trimethyl-(2-methacrylamidepropyl) ammonium chloride and N-(1,1-dimethyl-3-dimethylaminopropyl)acrylamide.

The ratio of a monomer containing cationic modifying group in cationic modified polyvinyl alcohol is 0.1-10 mol % and preferably 0.2-5 mol % against vinyl acetate.

Anionic modified polyvinyl alcohol includes, for example polyvinyl alcohol having an anionic group as described in JP-A No. 1-206088, a copolymer of vinyl alcohol and a vinyl compound having a water-soluble group as described in JP-A Nos. 61-237681 and 63-307979 and modified polyvinyl alcohol having a water-soluble group as described in JP-A No. 7-285265.

Further, nonionic modified polyvinyl alcohol includes, for example, polyvinyl alcohol derivatives, in which a polyalkylene oxide group is added to a part of vinyl alcohol, as described in JP-A No. 7-9758, and block copolymers of a vinyl compound having a hydrophobic group and vinyl alcohol as described in JP-A No. 8-25795. Polyvinyl alcohol may be utilized in combination of at least two types having different polymerization degrees or types.

The addition amount of inorganic particles utilized in an ink-absorbing layer is very much dependent on an ink absorption volume, a void ratio of an ink-absorbing layer, a type of inorganic particles and a type of a hydrophilic binder, however, is generally 5-30 g and preferably 10-25 g, per 1 m² of a recording medium.

Further, the ratio of inorganic particles to a water-soluble binder, which are utilized in an ink-absorbing layer, is generally 2:1-20:1 and specifically preferably 3:1-10:1.

In an ink-absorbing layer, the total amount of voids (void volume) is preferably not less than 20 ml/l m² of a recording medium. When the void volume is less than 20 ml/m², the ink absorption property is good when ink quantity at printing is small, while, when ink quantity becomes large, ink cannot be completely absorbed often resulting in problems of deteriorated image quality and causing retardation in a drying property.

In an ink-absorbing layer provided with an ink retaining ability, a void volume against a solid volume is designated as a void ratio. In the present invention it is preferable to set a void ratio to not less than 50%, because void can be efficiently formed without making the layer thickness unnecessarily large.

In a recording medium of the present invention, a polymer compound, containing a hydrophilic polymer compound which is provided with a plural number of side chains in the main chain and has been irradiated with ionizing rays to make cross-linking bonds between side chains, is preferably incorporated as a hydrophilic binder with respect to further increasing the effects of the present invention.

In the present invention, a hydrophilic polymer compound provided with a plural number of side chains in the main chain is a polymer compound which forms cross-linking bonds between side chains by irradiation of ionizing radiation. And the main chain is constituted of at least one type selected from (a) a saponification product of polyvinyl acetate, (b) polyvinyl acetal, (c) polyethylene oxide, (d) polyalkylene oxide, (e) polyvinyl pyrrolidone, (f) polyacrylamide, (g) hydroxyethyl cellulose, (h) methyl cellulose, (i) hydroxypropyl cellulose, (j) a derivative of at least one type of (a)-(i), and (k) a copolymer containing (a)-(j).

These hydrophilic polymer compounds are preferably resins which become hard to be dissolved in water after cross-linking by irradiation of ionizing radiation such as ultraviolet rays and electron rays.

Further, the side chain is preferably constituted of at least one modifying group selected from a photo-dimerization type, a photo-decomposition type, a photo-polymerization type, a photo-modification type and a photo-depolymerization type, and is preferably prepared by modifying at least one type of main chain selected from above (a)-(k).

A hydrophilic polymer compound, provided with a plural number of side chains in the main chain, utilized in the present invention does not require such as a polymerization initiator and a polymerization inhibitor for cross-linking as well as can restrain generation of non-reacted free radials after irradiation of ionizing radiation, resulting in restrain deterioration of crack resistance on aging. Further, a network of a porous layer containing a binder containing a polymer compound, in which a hydrophilic polymer compound, provided with a plural number of side chains in the main chain, of the present invention is irradiated by ionizing radiation to form cross-links between side chains, contains a cross-link at a long distance to provide a structure easy to retain many inorganic particles, resulting in uniform film formation with less amount of binder, that is, with a smaller ratio of binder to inorganic particles, different from a three-dimensional structure at a relatively short distance such as a porous network formed only by employing cross-linking agent, and a porous network formed by irradiating ionizing radiation to a hydrophilic polymer compound without a plural number of side chains in the main chain or a hydrophilic polymer compound having a low polymerization degree.

In this manner, since the smaller is the binder ratio against inorganic particles, the void ratio of an ink-absorbing layer increases to more easily retain ink (absorb ink), it is possible to prepare an inkjet recording medium provided with a porous layer which exhibits little cracking and peeling off of a recording layer before marking or printing after forming an inkjet recording medium, and strong resistance against stress by such as bending even after printing or marking, in addition to restrained ink overflow, rapid drying, strong coated film formation and strong bending resistance.

Therefore, prepared can be an inkjet recording medium exhibiting a high ink absorbability, improved moisture resistance, minimum crease and cracking, in addition to rapid ink drying rate.

Hydrophilic polymer compounds provided with a plural number of side chains in the main chain are preferably a diazo type of photo-dimerization type or those introduced with a cynamoyl group, a stylbazonium group or a stylquinolium group. Further, preferable is resin which can be dyed by a water-soluble dye such as an anionic dye after photo-cross-linking. Such resin, for example, includes resin provided with a cationic group such as a primary to quaternary ammonium group, for example, photosensitive resin (composition) described in such as JP-A Nos. 56-67309, 60-129742, 60-252341, 62-283339 and 1-198615; and resin provided with a group such as an azide group, which becomes an amino group and cationic by a curing process, for example, photosensitive resin (composition) described in JP-A 56-67309.

Concretely, for example, preferable is a resin composition which is provided with 2-azide-5-nitrophenylcarbonyloxyethylene structure represented by following formula (I) 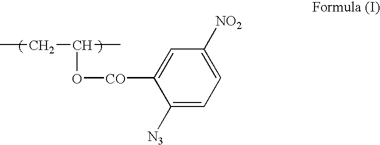
or 4-azide-3-nitrophenylcarbonyloxyethylene structure represented by following formula (II) 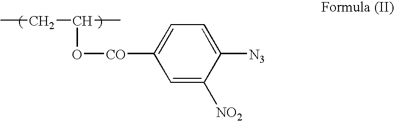
in a polyvinyl alcohol structure described in JP-A No. 56-67309.

Specific examples of the resin are described in examples 1 and 2 of said publication, and the constituting components of the resin and using ratio thereof are described in page 2 of said publication.

Further, photosensitive resin described in JP-A No. 60-129742 is polyvinyl alcohol type resin provided with a structure unit represented by the following formula (III) or (IV) in a polyvinyl alcohol structure.

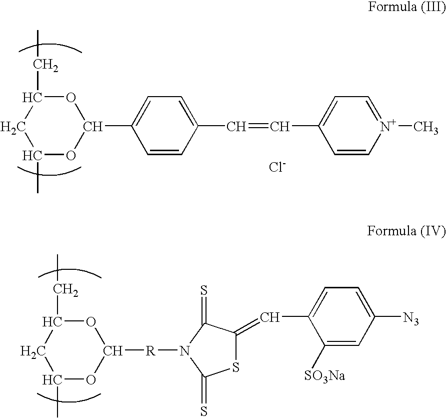

In the formulas, R₁ represents an alkyl group having a carbon number of 1-4 and A⁻ represents an anion. These are polyvinyl alcohol type resins provided with a structural unit having a stylylpyrridinium (stylubazorium) structure or a stylylquinolinium structure, which is prepared by reacting stylylpyrridinium salt or stylylquinorinium salt, having a formyl group, with polyvinyl alcohol or partly saponified polyvinyl acetate, and the manufacturing method is detailed in JP-A 60-129742 and can be easily manufactured referring thereto.

The ratio of a stylylpyrridinium group or a stylylquinolinium group in polyvinyl alcohol having a stylylpyrridinium group or a stylylquinolinium group is preferably 0.2-10.0 mol % per vinyl alcohol unit. Solubility into a coating solution can be improved by setting the ratio to not more than 10 mol %. Further, strength after cross-linking will be improved by setting the ratio to not less than 0.2 mol %.

Further, polyvinyl alcohol as a base in the above explanation may partly contain an un-saponified acetyl group and the content of an acetyl group is preferably less than 30%. And a polymerization degree thereof is preferably approximately 300-3000 and more preferably not less than 400. By setting the polymerization degree to not less than 300, irradiation time of radiation for a cross-linking reaction can be shortened resulting in improvement of productivity. Further, by setting the polymerization degree to not more than 3000, increase of viscosity can be restrained resulting in easy handling.

Herein, as a binder, utilized in combination may be a water-soluble resin such as gelatin, polyvinyl pyrrolidone, polyethylene oxide, polyacrylamide and polyvinyl alcohol together with the above-described hydrophilic polymer compound provided with a plural number of side chains in the main chain.

In the present invention, a photo-initiator or a photo-sensitizer is also preferably incorporated. These compounds may be dissolved or dispersed in a solvent, or may be chemically bonded to photosensitive resin.

A photo-initiator or a photo-sensitizer applied is not specifically limited, and those commonly known can be utilized.

A photo-initiator and photo-sensitizer utilized are not specifically limited, however, as an example, include benzophenones such as benzophenone, hydroxybenzophenone, bis-N,N-dimethylaminobenzophenone, bis-N,N-diethylaminobenzophenone, and 4-methoxy-4′-dimethylaminobenzophenone; thioxanthones such as thioxthantone, 2,4-diethylthioxthantone, isopropylthioxthantone, chlorothioxthantone and isopropoxychlorothioxthantone; anthraquinones such as ethylanthraquinone, benzanthraquinone, aminoanthraquinone and chloroanthraquinone; acetophenones; benzoinethers such as benzoinmethylether; 2,4,6-trihalomethyltriazines; 1-hydroxycyclohexyl phenyl ketone; 2,4,5-triarylimidazole dimmers such as a 2-(o-chlorophenyl)-4,5-diphenylimidazole dimer, a 2-(o-chlorophenyl)-4,5-di(m-methoxyphenyl)imidazole dimmer, a 2-(o-fluorophenyl)-4,5-diphenylimidazole dimer, a 2-(o-methoxyphenyl)-4,5-diphenyimidazole dimmer, a 2-(p-methoxyphenyl)-4,5-diphenyimidazole dimmer, a 2-di(p-methoxyphenyl)-5-phenyimidazole dimmer, a 2-(2,4-dimethoxyphenyl)-4,5-diphenyimidazole dimmer; benzyldimethy ketal, 2-benzyl-2-dimethylamino-1-(4-morphorinophenyl)-butane-1-one; 2-methyl-1-[4-(methylthio)phenyl]-2-morphorino-1-propanone; 2-hydroxy-2-mehyl-1-phenyl-propane-1-one; 1-[4-(2-hydroxyethoxy)-phenyl]-2-hydroxy-2-methyl-1-propane-1-one; phenanthrenquinone; 9,10-phenanthrenequinone; benzoins such as methylbenzoin and ethylbenzoin; acrydine derivatives such as 9-phenylacrydine and 1,7-bis(9,9′-acrydinyl)heptane; bisacylphosphine oxide; and mixtures thereof; which may be utilized alone or in combination.

Specifically, water-soluble initiators such as 1-[4-(2-hydroxyethoxy)-phenyl]-(2-hydroxy)-2-methyl-1-propane-1-one, 4-(2-hydroxyethoxy)-phenyl-(2-hydroxy-2-propyl)ketone, thioxthantone ammonium salt and benzophenone ammonium salt are preferable with respect to excellent miscibility as well as cross-linking efficiency. Further, in the case of utilizing ultraviolet rays as ionizing radiation, sensitizers such as thioxanthane, benzoin, benzoinalkyletherxanthone, dimehylxanthone, benzophnone, N,N,N′,N′-tetraethyl-4,4′-diaminobenzophenone and 1,1-dichloroacetophenone are preferable.

Herein, when a sensitizer is utilized, the using amount is preferably adjusted to approximately in a range of 0.2-10 weight % and preferably of 0.5-5 weight %, against ionizing radiation curable resin in a coating solution.

An accelerator may be added in addition to these initiators. Examples thereof include p-dimethylamino ethylbenzoate, p-dimethylamino isoamylbenzoate, ethanolamine, diethanolamine and triethanolamine. It may be blended at 0.05-3 weight % against ionizing radiation curable resin in a coating composition.

After coating a recording medium containing the above-described binder, the coated film is irradiated with ionizing radiation such as ultraviolet rays (a mercury lamp or a metal halide lamp). This irradiation of ionizing radiation causes a cross-linking reaction between side chains of a hydrophilic polymer compound to increase viscosity of an aqueous coated film and prevent from being fluidized (so-called to be set), resulting in formation of an uniform coated film. After irradiation of ionizing radiation, the coated film is dried resulting in preparation of an inkjet recording medium containing a porous layer provided with voids which primarily contains a hydrophilic binder and particles.

In the present invention, after irradiation of ionizing radiation, a coated layer is preferably dried to evaporate water-based solvents primarily containing water contained in the coated layer. Concretely, ionizing radiation is irradiated before an ink receiving layer after having been coated is pressing contacted to a heated mirror surface drum. Water-based solvents may be evaporated partly or mostly, however, coated film is preferably irradiated with ionizing radiation in a state of containing a hydrophilic solvent, and irradiation is more preferably performed immediately after the film having been coated. Thereby, since a porous layer can be formed by drying while the coated film is restrained from being fluidized due to cross-linking reaction between side chains of a hydrophilic polymer compound in the coated film, an inkjet recording medium containing an uniform porous layer can be prepared.

Ionizing radiation includes, for example, electron rays, ultraviolet rays, alpha rays, beta rays, gamma rays and X rays, and preferably utilized are electron rays and ultraviolet rays which exhibit little effect on a human body and easy handling as well as are prevailing in industrial applications.

In the case of employing electron rays as ionizing irradiation, the irradiation quantity of electron rays is preferably adjusted to approximately in a range of 0.1-20 Mrad. By setting to not less than 0.1 Mrad, a sufficient irradiation effect can be obtained, and by setting to not more than 20 Mrad, deterioration of a support, particularly such as paper or certain plastic, can be restrained. As an irradiation mode of electron rays, such as a scanning mode, a curtain beam mode and a broad beam mode are utilized, and an acceleration voltage at the time of irradiation of electron rays is preferably approximately 100-300 kV. Herein, an electron ray irradiation method exhibits, a higher productivity compared to ultraviolet ray irradiation, without no problem of odor and coloring due to addition of a sensitizer, in addition to advantage of providing a uniform cross-linking structure.

A hydrophilic polymer compound, which is provided with a plural number of side chains in the main chain and preferably utilized in the present invention, is capable of being sensitive to such as ultraviolet rays to perform cross-linking reaction without addition of such as the sensitizer described above, and such as an ultraviolet lamp (for example, a low-pressure, a medium-pressure and a high-pressure mercury lamps), a Xenon lamp, a tungsten lamp and a halogen lamp are utilized as a light source of ultraviolet rays, and ultraviolet rays having a strength of approximately 5000-8000 μW/cm² are preferably irradiated. Energy quantity required for curing is in a range of 0.02-20 kJ/cm².

Next, a porous ink-absorbing layer obtained via polymer phase separation will be described.

Examples of a method to form voids according to polymer phase separation include: (1) a wet phase separation method in which a polymer dissolved in a good solvent is coated on an ink-absorbing layer and then a poor solvent is over coated to generate voids; and (2) a dry phase separation method in which a coating solution containing a polymer, a good solvent of the polymer and a poor solvent of the polymer having a boiling point higher than that of the above good solvent is coated and the solvents are evaporated to dry, resulting in forming voids via micro phase separation.

Examples of the above mentioned polymer include polymers or cellulose derivatives derived from, for example: an olefin polymer, a vinyl polymer, an acrylic polymer, a styrene polymer, polyester, polyamide, polycarbonate, polyurethane, polysulfone and an epoxide.

A porous ink-absorbing layer containing organic particles and an organic binder resin will be described.

Examples of organic particles used in the porous ink-absorbing layer containing organic particles and organic binder resin include: polymethylmethacrylate, a polymer of multifunctional methacrylate, polyamide, polystyrene, polyvinylchloride, chloroprene rubber, nitrile rubber and styrene butadiene rubber.

Examples of the organic binder are common to those used for the porous structure ink-absorbing layer containing inorganic particles and an organic binder resin.

The ink-absorbing layer of the present invention preferably contains a cationic polymer in order to fix a dye-based ink, or as a dispersing agent of inorganic particles. Example of a cationic polymer include: polyethyleneimine, polyallylamine, polyvinylamine, a dicyandiamide polyalkylene polyamine condensate, a polyalkylene polyamine dicyandiamide ammonium salt condensate, a dicyandiamide formalin condensate, an epichlorohydrin dialkylamine addition polymerization product, diallyldimethylammonium chloride polymer, diallyldimethylammonium chloride-SO₂ copolymer, polyvinylimidazole, vinylpyrrolidone-vinylimidazole copolymer, polyvinylpyridine, polyamidine, chitosan, cationized starch, vinylbenzyltrimethylammonium chloride polymer, trimethyl(2-methacryloyloxyethyl)ammonium chloride polymer, dimethylaminoethylmethacrylate polymer. Further, included are: cationic polymers described in “Kagaku kogyo jiho” August 15/25, (1998) and polymer dye-fixing agents described in “Polymeric Agents” (1992) published by Sanyo Chemical Industries, Ltd.

Examples of a dispersant of inorganic particles include, in addition to the above cationic polymers, nonionic polymers such as polyacrylic acid and anionic polymers. In this case, a fixing agent for a dye-based ink can be applied by over coating a above mentioned polymer or a multivalent metal salt after coating the ink-absorbing layer.

In the ink-absorbing layer of the present invention or in a layer arbitrary provided if necessary, other additives besides those described above may be incorporated, examples of which include: polystyrene, polyacrylic acid ester, polymethacrylic acid ester, polyacrylamide, polyethylene, polypropylen, polyvinylchloride, and copolymers thereof; organic latex particles of, for example, urea resin or melamine resin; anionic, cationic, nonionic and amphoteric surfactants; UV absorbents disclosed in JP-A Nos. 57-74193, 57-87988 and 62-261476; anti-fading agents disclosed in JP-A Nos. 57-74192, 57-87989, 60-72785, 61-146591, 1-95091 and 3-13376; fluorescent whitening agents disclosed in JP-A Nos. 59-42993, 59-52689, 62-280069, 61-242871 and 4-219266; pH adjusting agents such as sulfuric acid, phosphoric acid, citric acid, sodium hydroxide, potassium hydroxide and potassium carbonate; an anti-foaming agent; an antiseptic agent; a thickening agent; an antistatic additive; and a matting agent; which are known in the art.

The ink-absorbing layer may be constituted of two or more layers, and in this case, the composition of those ink-absorbing layers may be mutually the same, or may be different.

The application method of the emulsion layer or ink-absorbing layer of the present invention on a support may be arbitrary selected from the methods known in the art, for example, a gravure coating method, a roll coating method, a rod bar coating method, an air-knife-coating method, a spray coating method, an extrusion coating method, a curtain coating method, and an extrusion coating method using a hopper disclosed in U.S. Pat. No. 2,681,294.

The recording medium of the present invention preferably has a back coat layer on the surface of the support reverse to the surface where the ink-absorbing layer is provided, in order to maintain curl balance. If there is no back coat layer, the recording medium may cause curl in a high humidity condition or in a low humidity condition and the recording head of an inkjet printer may be in touch with the recording medium while printing, resulting in staining the edge of the recording medium.

As a material which constitutes a back coat layer, for example, an aqueous emulsion resin, a water soluble resin, particles and an organic solvent soluble resin are usable. It is preferable that the material used to form the back coat layer is the same as the material used to form the aqueous emulsion resin layer provided between the above-mentioned ink-absorbing layer and the support because curl balance is easily obtained. In this case, it is preferable that the curl balance is controlled by changing the thicknesses of the aqueous emulsion resin layers on both surfaces of the support while considering the shrinkage stress of the ink-absorbing layer. Alternatively, a support having a back coat layer, such as a resin layer, may be used, and an ink-absorbing layer and a aqueous emulsion resin layer may be provided on the surface reverse to the back coated surface. For example, when an ink-absorbing layer is formed on the surface of a common cast-coated paper reverse to the cast coated surface, the cast coated layer works as a back coat layer. In the back coat layer, a matting agent or an antistatic agent may also be incorporated, if necessary, which may be applied in the same manner as the ink-absorbing layer.

The back coat layer may be applied before forming the ink-absorbing layer and the aqueous emulsion resin layer, or after forming those layers. When the back coat layer is applied before forming the ink-absorbing layer and the aqueous emulsion resin layer, the back coat layer is also subjected to the smoothing treatment, accordingly, the material for the back coat layer is preferably chosen so as not to stain the calender apparatus. For example, a resin on a rubber having Tg of below 0° C. may not be preferred.

At the time of forming an image by use of an inkjet recording medium of the present invention, inkjet ink can be utilized, and among them, preferably utilized is water-based dye ink containing such as a water-soluble dye, water and an organic solvent.

Water-soluble dyes utilized in the present invention include such as azo dyes, methine dyes, azomethine dyes, xanthene dyes, quinone dyes, phthalocyanine dyes, triphenylmethane dyes and diphenylmethane dyes, and specific examples thereof include, for example, dyes exemplified in JP-A No. 2002-264490.

Organic solvents utilized in the present invention are not specifically limited and are preferably water-soluble organic solvents which specifically include alcohols (such as methanol, ethanol, propanol, isopropanol, butanol, isobutanol, secondary butanol, tertiary butanol, pentanol, hexanol, cyclohexanol and benzyl alcohol), polyhydric alcohols (such as ethylene glycol, diethylene glycol, triethylene glycol, polyethylene glycol, propylene glycol, dipropylene glycol, polypropylene glycol, butylenes glycol, hexane diol, pentane diol, glycerin, hexane triol and thiodiglycol), polyhydric alcoholethers (ethylene glycol monomethylether, ethylene glycol monoethylether, ethylene glycol monobutylether, ethylene glycol monophenylether, diethylene glycol monomethylether, diethylene glycol monoethylether, diethylene glycol monobutylether, diethylene glycol dimethylether, propylene glycol monomethylether, propylene glycol monobutylether, ethylene glycol monomethylether acetate, triethylene glycol monomethylether, tiethylene glycol monoethylether, triethylene glycol monobutylether, triethylene glycol dimethylether, dipropylene glycol monopropylether and tripropylene glycol dimethylether), amines (such as ethanolamine, diethanolamine, triethanolamine, N-methyldiethanolamine, N-ethyldiethanolamine, morpholine, N-ethylmorpholine, ethylenediamine, triethylenetetramine, tetraethylene pentamine, polyethyleneimine, pentamethyldiethylenetriamine and tetramethylpropylenediamine), amides (such as formamide, N,N-dimethylformamide and N,N-dimethylacetoamide), heterocyclic rings (such as 2-pyrrolidone, N-methyl-2-pyrrolidone, N-cyclohexyl-2-pyrrolidone, 2-oxazolidone and 1,3-dimethyl-2-imidazolidine), sulfoxides (such as dimethylsulfoxide), sulfones (such as sulforane), sulfonates (such as sodium 1-butanesulfonate), urea, acetonitrile and acetone.

In ink of the present invention, various types of surfactants can be utilized. Surfactants utilized in the present invention are not specifically limited and include, for example, anionic surfactants such as dialkylsulfo succinates, alkylnaphthalene sulfonates and fatty acid salts; nonionic surfactants such as polyoxyethylene alkylethers, polyoxyethylene alkylallylethers, acetylene glycols and polyoxyethylene-polyoxypropylene blockcopolymers; and cationic surfactants such as alkylamines and quaternary ammonium salts. Particularly, anionic surfactants and nonionic surfactants are preferably utilized.

Further, in ink of the present invention, a polymer surfactant can be utilized. For example,, listed are styrene-acrylic acid-alkylester acrylate copolymer, styrene-acrylic acid copolymer, styrene-maleic acid-alkylester acrylate copolymer, a styrene-maleic acid copolymer, styrene-methacrylic acid-alkylester acrylate copolymer, styrene-methacrylic acid copolymer, styrene-maleic acid half-ester copolymer, vinylnaphthalene-acrylic acid copolymer and vinylnaphthalene-maleic acid copolymer.

In ink of the present invention, other than those explained above, well known various additives such as a viscosity controlling agent, a specific resistance controlling agent, a film forming agent, an ultraviolet absorbent, an anti-oxidant, an anti-fading agent, an anti-mold agent and anti-staining agent can be utilized by appropriate selection, depending on the purpose of improvement of ejection stability, adaptability to a print head and an ink cartridge, storage stability, an image lasting property and other various capabilities. For example, listed are oil particles of such as fluid paraffin, dioctylphthalate, tricresylphosphate and silicone oil; ultraviolet absorbents described in JP-A Nos. 57-74193, 57-87988 and 62-261476; anti-fading agents described in JP-A Nos. 57-74192, 57-87989, 60-72785, 61-146591, 1-95091 and 3-13376; and fluorescent whitening agents described in JP-A Nos. 59-42993, 59-52689, 62-280069, 61-242871 and 4-219266.

### EXAMPLES

In the following, the present invention will be concretely explained referring to examples, however, is not limited thereto. Herein, “part” and “%” used in the following examples represents “part by weight” and “% by weight”, respectively, unless otherwise mentioned.

<<Preparation of Inkjet Recording Medium>>

<Preparation of Recording Medium 1>

(Preparation of Silica Dispersion S-1)

An aqueous solution containing 10% of cationic polymer P-1, 10% of n-propanol and 2% of ethanol was prepared. Into 150 g of thus obtained cationic polymer solution, the following were added while the liquid was stirred at 3000 rpm at ambient temperature: (i) 436 g of silica dispersion (pH: 2.6, ethanol content: 0.5%) in which 23% of fumed silica having an average primary particle diameter of 7 nm (Aerosil 300 produced by Nippon Aerosil Co., Ltd.) was homogeneously dispersed; (ii) 3.6 g of boric acid; and (iii) 0.8 g of borax.

The resulting liquid was further dispersed with a pressure of 3 kN/cm² using a high pressure homogenizer produced by Sanwa Kogyo Co., Ltd., followed by adding pure water so that the silica content was 18% to obtain silica dispersion S-1. Obtained silica dispersion S-1 was filtered with TCP-10 filter produced by ADVANTEC. The average secondary particle diameter of silica was found to be 37 nm. The average secondary particle diameter of silica was measured by diluting the silica dispersion S-1 by 50 times using a dynamic light scattering particle sizer: Zetasizer 1000 HS produced by Malvern Instruments Ltd. 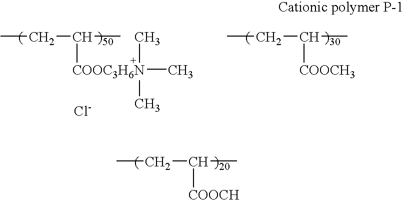
(Preparation of Ink-Absorbing Layer Coating Liquid 1)

While stirring at 40° C., 500 g of above silica dispersion S-1 was gradually added into 205 g of 8% aqueous solution of polyvinyl alcohol with a polymerization degree of 3500 (PVA235 produced by Kuraray Co., Ltd.), followed by adding pure water so that the total volume was 1000 ml. Thus ink-absorbing layer coating liquid 1 was prepared.

(Preparation of Recording Medium)

Above ink-absorbing layer coating liquid 1 was coated using a slide hopper so that the wet thickness was 180 μm on a multi paper “Marshmallow” (the basis weight of 209.3 g) produced by Oji Paper Co., Ltd., then the paper was dried with stepwise increasing the air flow temperature from 20 to 60° C., and finally the paper was kept in a thermostatic oven of which temperature was 40° C. and the relative humidity was 80% RH for 12 hours to prepare recording medium 1.

<Preparation of Recording Medium 2>

Aqueous emulsion resin T-XP163 (Tg=50° C.) produced by Seiko PMC Corp. was adjusted so as to give a solid amount of 5 g/m² and coated by a wire bar coating method on a multi paper “Marshmallow” (the basis weight of 209.3 g) produced by Oji Paper Co., Ltd., followed by drying to form aqueous emulsion resin layer 1.

Subsequently, on aqueous emulsion resin layer 1, ink-absorbing layer coating liquid 1 was coated using a slide hopper so that the wet thickness was 180 μm, then the paper was dried with stepwise increasing the air flow temperature from 20 to 60° C., and finally the paper was kept in a thermostatic oven of which temperature was 40° C. and the relative humidity was 80% RH for 12 hours to prepare recording medium 2.

<Preparation of Recording Medium 3>

Recording medium 3 was prepared in the same manner as recording medium 2 except that, after forming aqueous emulsion resin layer 1, a surface smoothing treatment was carried out using a calender widget equipped with a metal roll (also referred to as a calender treatment) under the following conditions: the metal roll surface temperature was 70° C.; the line pressure was 2 kN/cm; and the treatment velocity was 20 m/minute.

<Preparation of Recording Medium 4>

Recording medium 4 was prepared in the same manner as recording medium 3 except that the metal roll surface temperature was changed from 70° C. to 400C.

<Preparation of Recording Medium 5>

Recording medium 5 was prepared in the same manner as recording medium 4 except that the support was changed from a multi paper “Marshmallow” (the basis weight of 209.3 g) produced by Oji Paper Co., Ltd. to a cast coat paper for printing “Mirror Coat Satin Kanefuji” (the basis weight of 209.3 g)

Aqueous emulsion resin layer 1 and the layer formed by ink-absorbing layer coating liquid 1 were provided on the surface of the paper reverse to the surface having a cast coated layer.

<Preparation of Recording Medium 6>

Recording medium 6 was prepared in the same manner as recording medium 4 except that the line pressure at the calender treatment was changed to 4 kN/cm.

<Preparation of Recording Medium 7>

Recording medium 7 was prepared in the same manner as recording medium 4 except that the line pressure at the calender treatment was changed to 0.8 kN/cm.

<Preparation of Recording Medium 8>

Recording medium 8 was prepared in the same manner as recording medium 4 except that the metal roll surface temperature was changed to 30° C.

<Preparation of Recording Medium 9>

Recording medium 9 was prepared in the same manner as recording medium 4 except that the ink-absorbing layer was formed as follows using ink-absorbing layer coating liquid 2 instead of ink-absorbing layer coating liquid 1: ink-absorbing layer coating liquid 2 was coated so that the dry thickness of the layer was 20 μm, the paper was dried under a condition of 35° C. and 90% RH for 5 minutes, then dried at 120° C. for 3 minutes, and finally kept in a thermostatic oven of which temperature was 40° C. and the relative humidity was 80% RH for 12 hours. The porosity of ink-absorbing layer 2 thus obtained was 55%.

(Preparation of Ink-Absorbing Layer Coating Liquid 2)

In 100 g of 8% methyl cellosolve solution of cellulose acetate (acetylation degree of 55 and viscosity average polymerization degree of 170), 45 g of cyclohexanol was added to prepare ink-absorbing layer coating liquid 2.

<Preparation of Recording Medium 10>

Recording medium 10 was prepared in the same manner as recording medium 4 except that ink-absorbing layer coating liquid 3 having the following composition was used instead of ink-absorbing layer coating liquid 1, and the swelled thickness of the layer was changed to 100 μm.

(Preparation of Ink-Absorbing Layer Coating Liquid 3)

Into 800 g of pure water, 40 g of phenylcarbamoylated gelatin, 25 g of polyvinylpyrrolidone (molecular weight: 360,000), 12 g of polyethylene oxide (molecular weight: 100,000), 1 g of surfactants (Emulgen 120: produced by Kao Corp.), and 2.1 g of tetrakis(vinylsulfonylmethyl)methane were added and dissolved to prepare ink-absorbing layer coating liquid 3.

<Preparation of Recording Medium 11>

Recording medium 11 was prepared in the same manner as recording medium 4 except that aqueous emulsion resin HYDLITH2255R (Tg=22° C.) produced by Dainippon Ink & Chemicals Inc. was used instead of aqueous emulsion resin T-XP163 (Tg=50° C.) produced by Seiko PMC Corp. and that the metal roll surface temperature in the calender treatment was changed to 15° C.

<Preparation of Recording Medium 12>

Recording medium 12 was prepared in the same manner as recording medium 11 except that a cast coat paper for printing “Mirror Coat Satin Kanefuji” (the basis weight of 209.3 g) was used as a support instead of a multi paper “Marshmallow” (the basis weight of 209.3 g) produced by Oji Paper Co., Ltd.

Aqueous emulsion resin layer 2 and the layer formed by ink-absorbing layer coating liquid 1 were provided on the surface of the paper reverse to the surface having a cast coated layer.

<Preparation of Recording Medium 13>

Recording medium 13 was prepared in the same manner as recording medium 4 except that aqueous emulsion resin Chemipearl W700 (Tg=132° C.) produced by Mitsui Chemicals Inc. was used instead of aqueous emulsion resin T-XP163 (Tg=50° C.) produced by Seiko PMC Corp. and that the metal roll surface temperature in the calender treatment was changed to 122° C.

<Preparation of Recording Medium 14>

Recording medium 14 was prepared in the same manner as recording medium 4 except that aqueous emulsion resin T-XP104 (Tg=15° C.) produced by Seiko PMC Corp. was used instead of aqueous emulsion resin T-XP163 (Tg=50° C.) produced by Seiko PMC Corp. and that the metal roll surface temperature in the calender treatment was changed to 10° C.

<Preparation of Recording Medium 15>

Recording medium 15 was prepared in the same manner as recording medium 4 except that aqueous emulsion resin HYDLITH2255R (Tg=22° C.) produced by Dainippon Ink & Chemicals Inc. was coated by a wire bar coating method so as to give a solid amount of 6 g/m² on the reverse surface (BC surface) to the surface having the aqueous emulsion resin layer and the ink-absorbing layer, followed by drying and keeping in a thermostatic oven of which temperature was 40° C. and the relative humidity was 80% RH for 12 hours to form a back coat layer.

<Preparation of Recording Medium 16>

Recording medium 16 was prepared in the same manner as recording medium 15 except that aqueous emulsion resin HYDLITH2255R used in the back coat layer of recording medium 15 was replaced with the same amount of aqueous emulsion resin T-XP163 (Tg=50° C.).

<Preparation of Recording Medium 17>

Recording medium 17 was prepared in the same manner as recording medium 11 except that aqueous emulsion resin HYDLITH2255R (Tg=22° C.) produced by Dainippon Ink & Chemicals Inc. was coated by a wire bar coating method so as to give a solid amount of 6 g/m² on the reverse surface (BC surface) to the surface having the aqueous emulsion resin layer and the ink-absorbing layer, followed by drying and keeping in a thermostatic oven of which temperature was 40° C. and the relative humidity was 80% RH for 12 hours to form a back coat layer.

<Preparation of Recording Medium 18>

Recording medium 18 was prepared in the same manner as recording medium 4 except that aqueous emulsion resin L1 (styrene-butadiene copolymer, average particle diameter: 0.15 μm, Tg: 50° C.) was used instead of aqueous emulsion resin T-XP163 produced by Seiko PMC Corp.

<Preparation of Recording Medium 19>

Recording medium 19 was prepared in the same manner as recording medium 18 except that aqueous emulsion resin L1 (styrene-butadiene copolymer, average diameter: 0.15 μm, Tg: 50° C.) was coated by a wire bar coating method so as to give a solid amount of 6 g/m² on the reverse surface (BC surface) to the surface having the aqueous emulsion resin layer and the ink-absorbing layer, followed by drying and keeping in a thermostatic oven of which temperature was 40° C. and the relative humidity was 80% RH for 12 hours to form a-back coat layer.

<Preparation of Recording Medium 20>

Recording medium 20 was prepared in the same manner as recording medium 18 except that a cast coat paper for printing “Mirror Coat Satin Kanefuji” (the basis weight of 209.3 g) was used as a support instead of a multi paper “Marshmallow” (the basis weight of 209.3 g) produced by Oji Paper Co., Ltd.,

Aqueous emulsion resin layer and the layer formed by ink-absorbing layer coating liquid 1 were provided on the surface of the paper reverse to the surface having a cast coated layer.

<Preparation of Recording Medium 21>

Recording medium 21 was prepared in the same manner as recording medium 4 except that aqueous emulsion resin L2 (acryl ester copolymer, average particle diameter: 0.20 μm, Tg: 36° C.) was used instead of aqueous emulsion resin T-XP163 produced by Seiko PMC Corp. and that the metal roll surface temperature in the calender treatment was changed to 30° C.

<Preparation of Recording Medium 22>

Recording medium 22 was prepared in the same manner as recording medium 21 except that aqueous emulsion resin L2 (acryl ester copolymer, average particle diameter: 0.20 μm, Tg: 36° C.) was coated by a wire bar coating method so as to give a solid amount of 6 g/m² on the reverse surface (BC surface) to the surface having the aqueous emulsion resin layer and the ink-absorbing layer, followed by drying and keeping in a thermostatic oven of which temperature was 40° C. and the relative humidity was 80% RH for 12 hours to form a back coat layer. <Preparation of Recording Medium 23>

Recording medium 23 was prepared in the same manner as recording medium 21 except that a cast coat paper for printing “Mirror Coat Satin Kanefuji” (the basis weight of 209.3 g) was used as a support instead of a multi paper “Marshmallow” (the basis of 209.3 g) produced by Oji Paper Co., Ltd.

The aqueous emulsion resin layer and the layer formed by ink-absorbing layer coating liquid 1 were provided on the surface of the paper reverse to the surface having a cast coated layer.

TABLE 1

| | Constitution of support | | | | | | | |
|---|---|---|---|---|---|---|---|---|
| | | | | Surface smoothing | | | | |
| | | | | treatment | | | | |
| Recording | | Aqueous emulsion | | condition | | Ink- | Reverse | |
| medium | Paper | resin | | Temperature | Pressure | absorbing | surface | |
| No. | Support | Kind | Tg (° C.) | (° C.) | (kN/cm) | layer | (BC layer) | Remarkes |
| 1 | Marshmallow | — | — | — | — | Porous | — | Comp. |
| 2 | Marshmallow | T-XP163 | 50 | — | — | Porous | — | Comp. |
| 3 | Marshmallow | T-XP163 | 50 | 70 | 2 | Porous | — | Comp. |
| 4 | Marshmallow | T-XP163 | 50 | 40 | 2 | Porous | — | Inv. |
| 5 | Cast coat | T-XP163 | 50 | 40 | 2 | Porous | Cast coat | Inv. |
| | paper | | | | | | layer | |
| 6 | Marshmallow | T-XP163 | 50 | 40 | 4 | Porous | — | Inv. |
| 7 | Marshmallow | T-XP163 | 50 | 40 | 0.8 | Porous | — | Inv. |
| 8 | Marshmallow | T-XP163 | 50 | 30 | 2 | Porous | — | Inv. |
| 9 | Marshmallow | T-XP163 | 50 | 40 | 2 | Porous | — | Inv. |
| | | | | | | polymer | | |
| 10 | Marshmallow | T-XP163 | 50 | 40 | 2 | Swelled | — | Inv. |
| 11 | Marshmallow | 2255R | 22 | 15 | 2 | Porous | — | Inv. |
| 12 | Cast coat | 2255R | 22 | 15 | 2 | Porous | Cast coat | Inv. |
| | paper | | | | | | layer | |
| 13 | Marshmallow | Chemipearl | 132 | 122 | 2 | Porous | — | Inv. |
| | | W700 | | | | | | |
| 14 | Marshmallow | T-XP104 | 15 | 10 | 2 | Porous | — | Inv. |
| 15 | Marshmallow | T-XP163 | 50 | 40 | 2 | Porous | 2255R | Inv. |
| 16 | Marshmallow | T-XP163 | 50 | 40 | 2 | Porous | T-XP163 | Inv. |
| 17 | Marshmallow | 2255R | 22 | 15 | 2 | Porous | 2255R | Inv. |
| 18 | Marshmallow | L1 | 50 | 40 | 2 | Porous | — | Inv. |
| 19 | Marshmallow | L1 | 50 | 40 | 2 | Porous | L1 | Inv. |

Constitution of support

| | | | | Surface smoothing | | | | |
|---|---|---|---|---|---|---|---|---|
| Recording | | Water dispersible | | treatment condition | | Ink- | Reverse | |
| medium | Paper | emulsion | | Temperature | Pressure | absorbing | surface | |
| No. | Support | Kind | Tg (° C.) | (° C.) | (kN/cm) | layer | (BC layer) | Remarkes |
| 20 | Cast coat | L1 | 50 | 40 | 2 | Porous | Cast coat | Inv. |
| | paper | | | | | | layer | |
| 21 | Marshmallow | L2 | 36 | 30 | 2 | Porous | — | Inv. |
| 22 | Marshmallow | L2 | 36 | 30 | 2 | Porous | L2 | Inv. |
| 23 | Cast coat | L2 | 36 | 30 | 2 | Porous | Cast coat | Inv. |
| | paper | | | | | | layer | |

Inv.: Inventive example,
Comp.: Comparative example

<<Printing of Inkjet Image and Evaluation>>

On each recording medium obtained as described above, the following evaluation was conducted.

<Evaluation of Gloss>

Gloss of the ink-absorbing layer side surface of each recording medium was evaluated by comparing the gloss with that of a color paper for silver halide photography (color paper: glossy type QA paper produced by Konica Minolta Photo Imaging, Inc.), according to the following criteria.

1: Exhibiting gloss higher than the gloss of a silver halide photograph.

2: Exhibiting gloss almost comparative to the gloss of a silver halide photograph.

3: Exhibiting gloss slightly lower than the gloss of a silver halide photograph, however, suitable for practical use.

4: Exhibiting slight gloss which is lower than the gloss of a silver halide photograph.

5: Exhibiting no gloss.

[Evaluation of Cockling Resistance]

A black solid image was printed on each recording medium using an inkjet printer PM-G800 (produced by Seiko Epson Corp.) and the recording sheet was evaluated for the resistance for cockling according to the following criteria. When a recording medium is ranked as any of A-D, it was evaluated as suitable for practical use.

A: Exhibiting the same extent of cockling on the surface as that of non-printed area.

B: Exhibiting almost no cockling on the surface and beauty of the surface being maintained

C: Exhibiting slight cockling on the surface, however, the beauty of the surface being maintained.

D: Exhibiting small cockling on the surface, however, the beauty of the surface almost being maintained.

E: Exhibiting large cockling on the surface and the beauty of the surface being lost.

F: Exhibiting significantly large cockling on the surface and the beauty of the surface being severely spoiled.

<Evaluation of Ink-Absorbability>

The ink-absorbability was evaluated by printing a green solid image on each recording mediun under a condition of 23° C. and 55% RH using an inkjet printer PM-G800 (produced by Seiko Epson Corp.). Each recording medium was evaluated after it was kept at 23° C. for one day.

The area where a solid image was printed of each recording medium was visually observed to evaluate ink-absorbability via beading resistance. When a recording medium is ranked as any of 1-3, it was evaluated as suitable for practical use.

1: No unevenness in solid image was recognized when observed at a distance of 30 cm.

2: Slight unevenness in solid image was recognized when observed at a distance of 30 cm, however, no unevenness was recognized when observed at a distance of 45 cm.

3: Slight unevenness in solid image was recognized when observed at a distance of 45 cm, however, no unevenness was recognized when observed at a distance of 60 cm.

4: Slight unevenness in solid image was recognized when observed at a distance of 60 cm.

5: Clear unevenness was recognized when observed at a distance of 60 cm.

<Evaluation for Printing Stain Resistance>

Each recording medium was cut into 30 postcard size sheets and a cyan solid image was printed onto the 30 postcard size sheets, then, examined was the occurrence of a stain of the sheets due to contact with the printer head while printing. When a recording medium largely curled, the printer head touched with the recording medium, whereby an edge of the recording medium was stained.

A: No stain of an edge was observed.

B: A slight stain was observed on the edges of 1-2 sheets among the 30 sheets.

C: A slight stain was observed on the edges of 3-5 sheets among the 30 sheets.

D: A large notable stain was observed on the edges of 2 or more sheets among the 30 sheets.

<Evaluation for Image Bleeding Resistance>

Using an inkjet printer PM-G800 (produced by Seiko Epson Corp.), solid images of red, blue and green were printed on each recording medium and, on the above images, the following Chinese characters:

[symbol]

[symbol]

were printed with a black ink. The images were kept under a condition of 40° C. and 80% RH for 3 days and image bleeding was visually evaluated according to the following criteria.

A: On each solid image, each black character image was clearly recognized and no bleeding was observed.

B: Slight bleeding was observed in images of a complicated characters.

C: Bleeding was observed in character images depending on the color of the solid image, however, all the character images were recognizable and suitable for practical use.

D: All the black character images were recognizable, however, image bleeding was observed over the whole images and not suitable for appreciation.

E: Notable bleeding was observed on each black character image and some of the character images could not be recognized.

<Evaluation for Calender Roll Stain Resistance>

In the production process of each recording medium, 30 A4 size (210×297 mm) sheets were subjected to a surface smoothing treatment under the condition shown in Table 1, then the existence or nonexistence of stain on the metal roll of the calender apparatus was visually observed and evaluated according to the following criteria.

A: No stain was observed.

B: Slight stain was observed.

C: Obvious stain was observed.

The results were summarized in Table 2.

TABLE 2

| | | | Image | | Printing | Calender | |
|---|---|---|---|---|---|---|---|
| Recording | | Cockling | bleeding | Ink- | stain | stain | |
| medium No. | Gloss | resistance | resistance | absorbability | resistance | resistance | Remarks |
| 1 | 5 | F | A | 1 | B | — | Comp. |
| 2 | 4 | E | A | 1 | B | — | Comp. |
| 3 | 3 | A | D | 1 | B | C | Comp. |
| 4 | 1 | B | A | 1 | B | A | Inv. |
| 5 | 1 | B | A | 1 | A | A | Inv. |
| 6 | 1 | A | B | 1 | B | A | Inv. |
| 7 | 2 | B | A | 1 | B | A | Inv. |
| 8 | 2 | B | A | 1 | B | A | Inv. |
| 9 | 1 | B | A | 2 | B | A | Inv. |
| 10 | 1 | B | A | 3 | B | A | Inv. |
| 11 | 1 | B | A | 1 | B | A | Inv. |
| 12 | 1 | B | A | 1 | A | A | Inv. |
| 13 | 2 | B | A | 1 | B | A | Inv. |
| 14 | 2 | B | A | 1 | B | A | Inv. |
| 15 | 1 | B | A | 1 | A | A | Inv. |
| 16 | 1 | B | A | 1 | A | A | Inv. |
| 17 | 1 | B | A | 1 | A | A | Inv. |
| 18 | 1 | B | A | 1 | B | A | Inv. |
| 19 | 1 | B | A | 1 | A | A | Inv. |
| 20 | 1 | B | A | 1 | A | A | Inv. |
| 21 | 1 | B | A | 1 | B | A | Inv. |
| 22 | 1 | B | A | 1 | A | A | Inv. |
| 23 | 1 | B | A | 1 | A | A | Inv. |

Inv.: Inventive example,
Comp.: Comparative example

As is clear from Table 2, the recording media satisfying the condition prescribed in the present invention caused no stain on the metal roll of the calender apparatus, and found to be superior, as a recording medium, in gloss, resistance for cockling, resistance for image bleeding, ink-absorbability and resistance for stain of the recording medium, when compared with those of comparative examples.

What is claimed is:

1. An inkjet recording medium comprising a support containing a cellulose pulp having thereon an ink-absorbing layer, wherein the support is applied with an aqueous coating liquid comprising an aqueous emulsion resin on a surface where the ink-absorbing layer is to be provided, followed by being pressed with a surface smoothing roller at a temperature not higher than a glass transition temperature of the aqueous emulsion resin.

2. The inkjet recording medium of claim 1, wherein the glass transition temperature of the resin is in the range of 20 to 100° C.

3. The inkjet recording medium of claim 1, wherein the support is pressed at a line pressure of 1 to 5 kN/cm.

4. The inkjet recording medium of claim 1, wherein the ink-absorbing layer has a porous structure.

5. The inkjet recording medium of claim 4, wherein the porous structure comprises inorganic particles and an organic binder.

6. The inkjet recording medium of claim 1, wherein the support is provided with a back coat layer on a surface of the support reverse to a surface having-the ink-absorbing layer.

7. A method for producing an inkjet recording medium comprising the steps of:
(i) applying an aqueous coating liquid comprising an aqueous emulsion resin on a support containing a cellulose pulp;
(ii) carrying out a surface smoothing treatment by pressing the support applied with the aqueous coating liquid with a roller at a temperature not higher than a glass transition temperature of the aqueous emulsion resin; and
(iii) providing an ink-absorbing layer on a surface of the support where the aqueous coating liquid is applied.

8. The method of claim 7, wherein the glass transition temperature of the resin is in the range of 20 to 100° C.

9. The method of claim 7, wherein the support is pressed at a line pressure of 1 to 5 kN/cm.

10. The method of claim 7, wherein the ink-absorbing layer has a porous structure.

11. The method of claim 7, wherein the porous structure comprises inorganic particles and an organic binder.

12. The method of claim 7, wherein the support is provided with a back coat layer on a surface of the support reverse to a surface having the ink-absorbing layer.
